(19) United States
(12) Patent Application Publication
(10) Pub. No.: US 2022/0035898 A1
(43) Pub. Date: Feb. 3, 2022

(54) Audio CAPTCHA Using Echo

(71) Applicant: Nuance Communications, Inc., Burlington, MA (US)

(72) Inventor: Melanie Thibeault, Montréal (CA)

(21) Appl. No.: 16/945,440

(22) Filed: Jul. 31, 2020

(51) Int. Cl. G06F 21/32; G10L 17/24; G10K 15/12; G10L 21/003

(52) U.S. Cl. CPC G06F 21/32; G10L 17/24; G06F 2221/2133; G10L 21/003; G10K 15/12

(57) ABSTRACT

A system for determining that a user is either a human and non-human may comprise an interactive voice component and an audio validation component. The audio validation component may implement a test to determine that the user is one of human and non-human. The test may comprise an echo perturbation effect applied to at least a portion of a challenge phrase to form a modified challenge phrase. The test may further comprise the modified challenge phrase issued to the user, a response received from the user, and an evaluation of the response. When the response is a correct response to the challenge phrase, the user is designated as human, and when the response is an incorrect response to the challenge phrase, the user is designated as non-human. The interactive voice component may be an IVR system, and the audio validation component comprises an auditory CAPTCHA.

### BACKGROUND

In interactive situations, it may be necessary and/or desirable to distinguish between a human user and an artificial (e.g., computer-based) entity. For example, an automated sign-in facility can be overwhelmed by an artificial entity (e.g., a bot) because such an entity can repeatedly submit sign-in credentials at a speed much greater than a human user.

To mitigate such bot attacks, a CAPTCHA (Completely Automated Public Turing test to tell Computers and Humans Apart) may be employed as a checkpoint or selective gateway to the interactive facility, only allowing a user to access the interactive facility if the user is determined to be a human user. A CAPTCHA is a type of “challenge-response” test used to determine if a user is human. The CAPTCHA may present a challenge to the user, e.g., one or more images, along with a requirement that the user interpret the image(s). The image(s) may be distorted in some way that would be difficult for a bot to decode, or the challenge may include an image analysis task that would be difficult for a bot to successfully perform.

To accommodate people with motor or visual disabilities, there is a need to provide an auditory CAPTCHA in any situation that would require a visual CAPTCHA. Further, interactive voice response (IVR) systems are increasingly receiving bot calls. Although some bot calls are simply spam and relatively harmless, other bot calls are designed to bypass IVR systems and reach live agents, even with existing auditory CAPTCHA schemes, thereby increasing the call-handling load on the live agents.

### SUMMARY

The described embodiments are directed to a system for, and method of, performing audio validation of a user. The audio validation provides an indication that the user is either human or non-human. The described embodiments may utilize an auditory CAPTCHA to perform the audio validation. The auditory CAPTCHA, which implements a challenge-response test to determine whether the user is human or non-human, may apply an echo perturbation effect to the challenge portion of the challenge-response portion of the test. The described embodiments, in addition to the echo perturbation effect, may also add other non-echo effects to the challenge portion of the challenge-response test. The other non-echo effect may include, but are not limited to, music, a noise distribution, a pure tone, compression, jitter, shimmer, a distorted pitch, and volume variations. Other such audio effects known in the art may also be used.

Embodiments of the invention that employ the echo perturbation effect on challenge phrases have been demonstrated as being effective against recognition by non-human users, while being relatively easy for human users to interpret (i.e. low cognitive effort, and the auditory stimuli are comfortable and easy to understand). The described embodiments thus provide an improved audio presentation of the challenge phrase, thereby increasing the likelihood of correctly distinguishing between a human user and a non-human user.

In one aspect, the invention may be a processor-based system comprising an interactive voice component and an audio validation component operatively coupled to the interactive voice component. The interactive voice component may be configured to receive an auditory input from a user, and to provide an auditory output to the user in response to the auditory input. The audio validation component may be configured to implement a test to determine that the user is one of human and non-human. The test may comprise a challenge phrase generated by the audio validation component, and an effect applied to at least a portion of the challenge phrase. The effect may comprise an echo perturbation to form a modified challenge phrase to be transmitted to the user. The test may further comprise an evaluation of a response received from the user responsive to the modified challenge phrase to determine that the response is a correct response to the challenge phrase. When the response is determined to be a correct response to the challenge phrase, the user is designated as human. When the response is determined to be an incorrect response to the challenge phrase, the user is designated as non-human.

The audio validation component may comprise an auditory CAPTCHA. The interactive voice component may be an interactive voice response (IVR) system. The echo perturbation may be implemented as:

C(t)+A*C(t−D),

where t is time, C(t) is the challenge phrase, A is an amplitude value, and D is a delay value. The amplitude value may be in the range of 0.2 to 0.7, and the delay value may be in the range of 0.2 seconds to 0.7 seconds.

The effect applied to the challenge phrase may further comprise one or more non-echo effects in addition to the echo perturbation. The one or more non-echo effects may be selected from a pool of non-echo effects. The pool of non-echo effects may comprise (i) music, (ii) noise distribution, (iii) one or more pure tones, (iv) compression, (v) jitter, (vi) shimmer, and/or (vii) distorted pitch.

The challenge phrase may comprise a series of symbols. The symbols may comprise one or more of numbers, letters, phonemes, and words.

In another aspect, the invention may be a processor-implemented method of determining that a user of an interactive voice component is one of human and non-human comprising, by an audio validation component comprising a processor operatively coupled to a memory device, generating a challenge phrase, and applying an effect to at least a portion of the challenge phrase to form a modified challenge phrase. The effect may comprise an echo perturbation. The method may further comprise issuing the modified challenge phrase to the user, receiving a response from the user, and evaluating the response to determine that the response is a correct response to the challenge phrase. When the response is determined to be a correct response to the challenge phrase, designating the user as human. When the response is determined to be an incorrect response to the challenge phrase, designating the user as non-human.

The method may further comprise implementing the echo perturbation as:

C(t)+A*C(t−D),

where t is time, C(t) is the challenge phrase, A is an amplitude value, and D is a delay value. The amplitude value may be in the range of 0.2 to 0.7, and the delay value is in the range of 0.2 seconds to 0.7 seconds. The method may further comprise applying one or more non-echo effects to the challenge phrase, in addition to the echo perturbation. The method may further comprise selecting the one or more non-echo effects from a pool of non-echo effects. The pool of non-echo effects comprises (i) music, (ii) noise distribution, (iii) one or more pure tones, (iv) compression, (v) jitter, (vi) shimmer, and/or (vii) distorted pitch.

The method may further comprise forming the challenge phrase that comprises a series of symbols, wherein the symbols may comprise one or more of numbers, letters, phonemes, and words.

In another aspect, the invention may be a processor-based system comprising at least one processor, and a memory comprising code stored therein that, when executed by at least one processor, performs a method of implementing a test to determine that the user is one of human and non-human. The test may comprise a challenge phrase issued to the user, and an effect applied to the challenge phrase. The effect may comprise an echo perturbation, and an evaluation of a response received from the user to determine that the response is a correct response to the challenge phrase. When the response is determined to be a correct response to the challenge phrase, the user is designated as human. When the response is determined to be an incorrect response to the challenge phrase, the user is designated as non-human.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A shows an example embodiment of a system in which the described embodiments may be used.

FIG. 1B shows a flow diagram of one embodiment of an audio validation component as described herein.

FIG. 2 is a diagram of an example internal structure of a processing system that may be used to implement one or more of the embodiments herein.

FIG. 3 illustrates an example embodiment of a method of determining that a user of an interactive voice component is one of human and non-human.

### DETAILED DESCRIPTION

A description of example embodiments follows.

The teachings of all patents, published applications and references cited herein are incorporated by reference in their entirety.

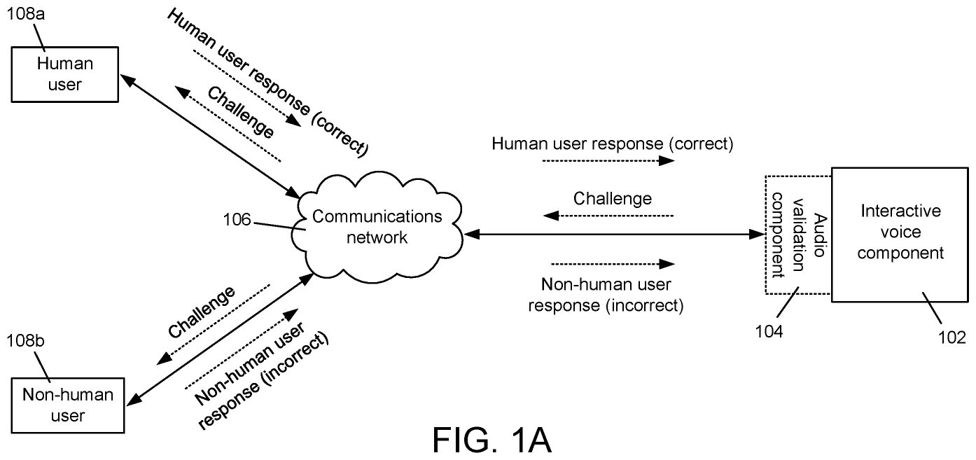

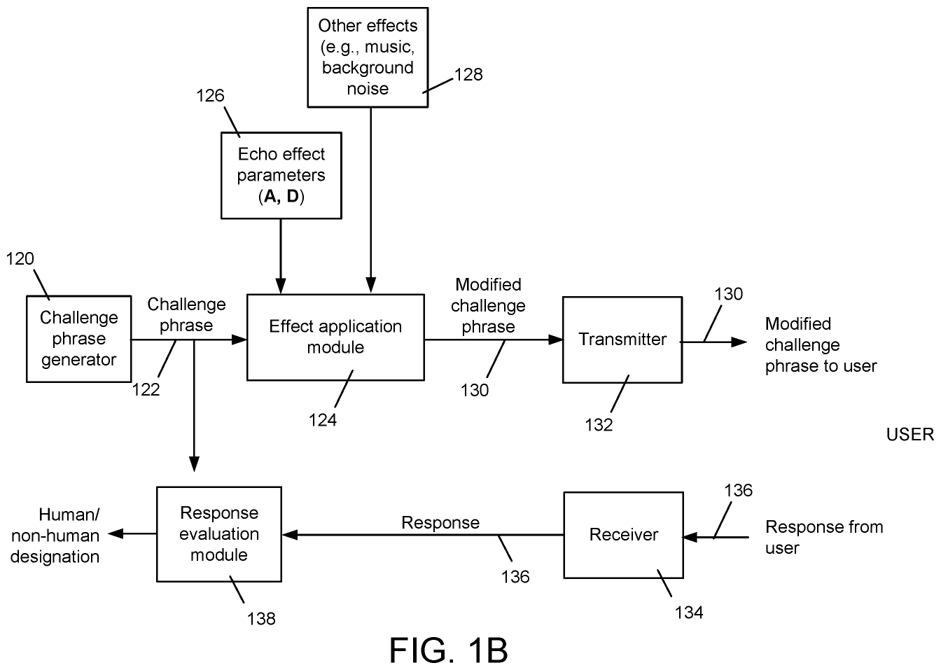

FIG. 1A illustrates an example embodiment of a system in which the described embodiments may be used. FIG. 1A shows an interactive voice component 102, an audio validation component 104 (in this example a CAPTCHA), a communications network 106 (e.g., an analog or digital telephone network), and a human user 108a, and a non-human user 108b. While both the human user 108a and the non-human user 108b are shown in the example embodiment for description purposes, it should be understood that both human and non-human users do not necessarily communicate with the audio validation component 104 and the interactive voice component 102 at the same time. The interactive voice component 102 may be an interactive voice response (IVR) system, although in other embodiments the interactive voice components may be other systems that need to distinguish between human and non-human users. For example, the interactive voice component may be a website that relies on audio input to provide accessibility for users with visual impairments.

The interactive voice component 102 may be configured to receive an auditory input from a user, and to provide an auditory output to the user in response to the user's auditory input. In the described embodiments, the audio validation component 104 may be operatively coupled to the interactive voice component 102 so that the audio validation component 104 operates as an intermediary between the user 108 and the interactive voice component 102. While the example embodiment of FIG. 1A shows the audio validation component 104 as a separate component operatively coupled to the interactive voice component 102, in other embodiments the audio validation component 104 may be a sub-component of the interactive voice component.

In the described embodiments, the audio validation component 104 implements a test to determine if the user is human or non-human (e.g., a device or software that can execute commands, reply to messages, or perform routine tasks, often referred to as a bot). The test may comprise generating a challenge phrase and issuing the challenge phrase to the user. The challenge phrase may comprise a carrier phrase that instructs the user how to respond (e.g., “For security reasons, I need to verify that this is a live call. Please repeat the following numbers”), followed by a series of symbols. The symbols may comprise numbers, letters, phonemes, words, strings of words (e.g., an answer to a question), or other such utterances, and the symbols may be selected from a pool of symbols. In some embodiments, the symbols may be randomly selected from the pool of symbols. In some embodiments, the challenge phrase may be a trivia question or mathematical question that requires a number, word or string of words for an answer.

The audio validation component may apply an effect to all or a portion of the challenge phrase. The applied effect serves to deteriorate the challenge phrase to degrade the ability of a non-human user to construe the challenge phrase. In some embodiments, applying an effect to the challenge phrase may comprise overlaying the effect on the challenge phrase (e.g., a superposition of the effect and the challenge phrase). In other embodiments, applying the effect may comprise a modulation or other manipulation of the challenge phrase. The described embodiments rely on a human's capacity to understand such deteriorated speech.

In the described embodiments, the effect comprises an echo perturbation. In alternative embodiments, the effect may comprise one or more non-echo effects applied to the challenge phrase, in addition to the echo perturbation. In some embodiments, the non-echo effect(s) applied to the challenge phrase may be selected from a pool of non-echo effects, and applied with the echo perturbation to different challenge phrases or across a single challenge phrase.

In some embodiments, the effect may be applied to only the symbols to be construed. In alternative embodiments, the effect may be applied to some or all the carrier phrase, in addition to the symbols to be construed. Applying the effect to more than just the symbols may decrease the likelihood that a non-human user will correctly construe the symbols. The applied echo represents very clear and loud extra speech, which a non-human user will transcribe in its recognition process. Accordingly, if more portions of the challenge phrase have the echo perturbation applied, then more extra speech will exist for the recognizer at the non-human user to transcribe and attempt to decode.

The non-echo effects may comprise music, noise distribution, one or more pure tones, compression, jitter, shimmer, and/or distorted pitch. The music effect may comprise an overlay of music onto the challenge phrase. The music may comprise instrumental-only, vocal-only, instrumental with vocals, or combinations of these with other sounds. The music may include any music genre, including ambiance music (e.g., “elevator music”). The music may have an amplitude of between 40 dB to 80 dB relative to the amplitude of the challenge phrase.

A noise distribution effect may comprise an overlay of noise of a certain statistical distribution, for example white noise, pink noise, or brown noise, although other noise distributions may alternatively be used. In some embodiments, the noise may be ambient background noise such as coffee shop background noise or city traffic background noise. The noise may have an amplitude of between 40 dB to 80 dB relative to the amplitude of the challenge phrase.

A pure tone effect may be an overlay of a narrow-band tone (e.g., percent bandwidth less than or equal to 10%) centered at a particular frequency. The center frequency may range from 100 Hz to 2000 Hz, although other frequency ranges may also be used.

A compression effect may comprise a modification of the challenge phrase by compression, for example by dynamic range compression or algorithmic compression of a digital representation of the challenge phrase.

A jitter effect may comprise a modification of the challenge phrase by shifting portions of the challenge phrase waveform in time. The jitter may be applied on a cycle-by-cycle basis, or on larger portions of the challenge waveform.

A shimmer effect may comprise manipulating the volume (i.e., amplitude) of the challenge phrase waveform. The challenge waveform may be viewed as a sequence of very short tone bursts. The shimmer effect is a variation in the volume of these tone bursts during a held sound.

A distorted pitch effect may comprise manipulating the constituent frequencies of the challenge phrase waveform.

The described embodiments apply an effect, as described herein, to the challenge phrase by modifying the challenge phrase (e.g., prompted instructions to repeat a sequence). In an example embodiment, a procedure to add an echo perturbation to a challenge phrase may comprise:
1) Add an interval of silence to the end of an audio file that represents the challenge phrase. In this example embodiment, the interval of silence is set to be 30 percent of the length of the audio file. The length of the interval of silence may be adjusted to be longer or shorter as needed, based on the delay parameter D defined below.
2) For each sample, modify the sample according to:

modified sample=C(t)+A*C(t−D),

where t is time, C(t) is the challenge phrase, A is an amplitude value, and D is a delay value.
3) Gradually attenuate the amplitude of the modified sample over the interval of silence.

The example embodiments use a value of 0.3 for A and a value of 0.3 for D, although for other embodiments the values of A and D may range from 0.2 to 0.7. These values and ranges should not be construed as limiting, as other values may alternatively be used. The amplitude may be gradually attenuated through the interval of silence in a linear or non-linear manner.

FIG. 1B shows a flow diagram of one embodiment of an audio validation component 104 as described herein. A challenge phrase generator 120 may generate a challenge phrase 122 and forward the challenge phrase 122 to an effect application module 124. The effect application module 124 may receive echo effect parameters 126 (e.g., amplitude A, delay D) to implement the echo perturbation. The effect application module 124 may also receive other effects 128 (e.g., music and/or background noise) to add to the challenge phrase 122 in addition to the echo perturbation. The effect application module may add the effect to the challenge phrase 122 to form a modified challenge phrase 130. A transmitter 132 transmits the modified challenge phrase 130 to a user (human or non-human), and a receiver 134 receives a response from the user. The transmitter 132 and receiver 134 may not be complete transmit/receive devices. In some embodiments, the transmitter 132 and the receiver 134 may perform formatting procedures that compile or decompile information into suitable formats. In other embodiments, the transmitter 132 and the receiver 134 may simply be pass-through components that do not format or otherwise modify information. A response evaluation module 138 receives the received response 136 and evaluates the response 136, based on the challenge phrase, to designate the user as human or non-human, as described herein.

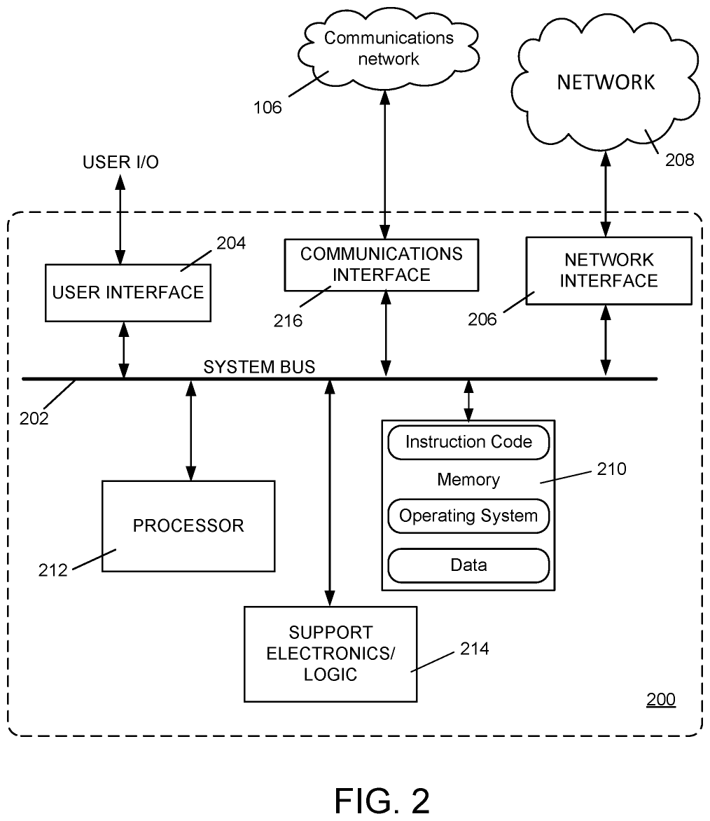

FIG. 2 is a diagram of an example internal structure of a processing system 200 that may be used to implement one or more of the embodiments herein. Each processing system 200 contains a system bus 202, where a bus is a set of hardware lines used for data transfer among the components of a computer or processing system. The system bus 202 is essentially a shared conduit that connects different components of a processing system (e.g., processor, disk storage, memory, input/output ports, network ports, etc.) that enables the transfer of information between the components.

Attached to the system bus 202 is a user I/O device interface 204 for connecting various input and output devices (e.g., keyboard, mouse, displays, printers, speakers, etc.) to the processing system 200. A network interface 206 allows the computer to connect to various other devices attached to a network 208. Memory 210 provides volatile and non-volatile storage for information such as computer software instructions used to implement one or more of the embodiments of the present invention described herein, for data generated internally and for data received from sources external to the processing system 200.

A central processor unit 212 is also attached to the system bus 202 and provides for the execution of computer instructions stored in memory 210. The system may also include support electronics/logic 214, and a communications interface 216. The communications interface may comprise the communications network 106 described with reference to FIG. 1A.

In one embodiment, the information stored in memory 210 may comprise a computer program product, such that the memory 210 may comprise a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

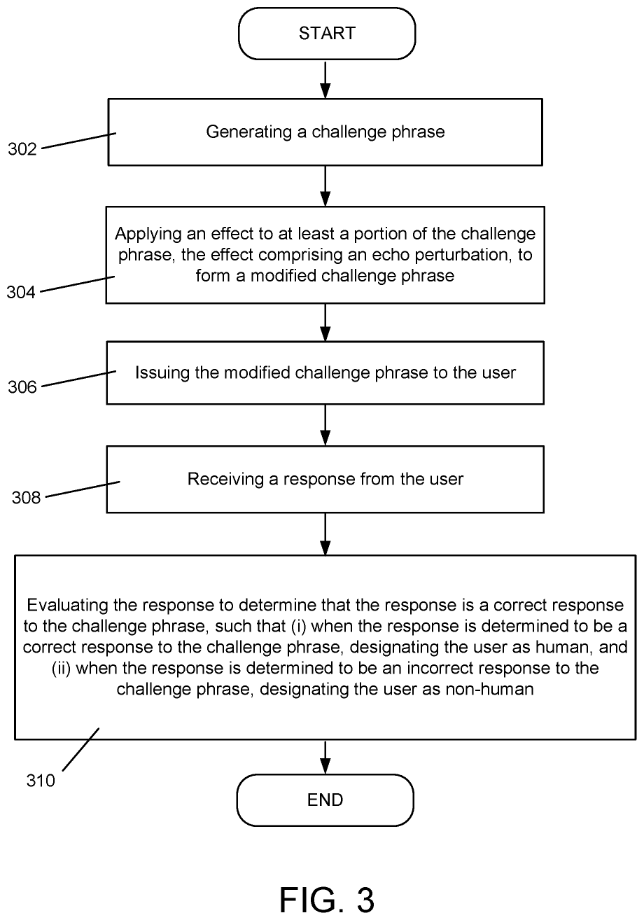

FIG. 3 illustrates an example embodiment of a method of determining that a user of an interactive voice component is one of human and non-human. The method may comprise generating 302 a challenge phrase and applying 304 an effect to at least a portion of the challenge phrase to form a modified challenge phrase. The effect may comprise an echo perturbation. The method may further comprise issuing 306 the challenge phrase to the user, and receiving 308 a response from the user. The method may further comprise evaluating 310 the response to determine that the response is a correct response to the challenge phrase, such that (i) when the response is determined to be a correct response to the challenge phrase, designating the user as human, and (ii) when the response is determined to be an incorrect response to the challenge phrase, designating the user as non-human.

An experimental evaluation of the described embodiments was conducted using 10 different challenge phrases, each with 10 delays D and 10 different amplitudes, for a total of 1000 challenge candidates. Two different recognizers were used to evaluate the 1000 candidates. 877 of the 1000 candidate phrases were not recognized properly, which increased to 968 out of 1000 when the two faintest (lowest amplitude) candidates were discarded. The experimental evaluation demonstrated that even smaller echo perturbations are highly-effective against non-human users. The smaller echo perturbations are desirable because they preserve human perception/understanding, thereby making it easier for a human user to construe the challenge phrase.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While example embodiments have been particularly shown and described, it will be understood by those skilled in the art that various changes in form and details may be made therein without departing from the scope of the embodiments encompassed by the appended claims.

What is claimed is:

1. A processor-based system comprising:
an interactive voice component, configured to receive an auditory input from a user, and to provide an auditory output to the user in response to the auditory input; and
an audio validation component operatively coupled to the interactive voice component, the audio validation component configured to implement a test to determine that the user is one of human and non-human, the test comprising:
a challenge phrase generated by the audio validation component;
an effect applied to at least a portion of the challenge phrase, the effect comprising an echo perturbation to form a modified challenge phrase to be transmitted to the user; and
an evaluation of a response received from the user responsive to the modified challenge phrase to determine that the response is a correct response to the challenge phrase, such that (i) when the response is determined to be a correct response to the challenge phrase, the user is designated as human, and (ii) when the response is determined to be an incorrect response to the challenge phrase, the user is designated as non-human.

2. The processor-based system of claim 1, wherein the audio validation component comprises an auditory CAPTCHA.

3. The processor-based system of claim 1, wherein the interactive voice component is an interactive voice response (IVR) system.

4. The processor-based system of claim 1, wherein the echo perturbation is implemented as C(t)+A*C(t−D), where t is time, C(t) is the challenge phrase, A is an amplitude value, and D is a delay value.

5. The processor-based system of claim 4, wherein the amplitude value is in the range of 0.2 to 0.7, and the delay value is in the range of 0.2 seconds to 0.7 seconds.

6. The processor-based system of claim 1, wherein the effect applied to the challenge phrase further comprises one or more non-echo effects in addition to the echo perturbation.

7. The processor-based system of claim 6, wherein the one or more non-echo effects are selected from a pool of non-echo effects.

8. The processor-based system of claim 7, wherein the pool of non-echo effects comprises (i) music, (ii) noise distribution, (iii) one or more pure tones, (iv) compression, (v) jitter, (vi) shimmer, and/or (vii) distorted pitch.

9. The processor-based system of claim 1, wherein the challenge phrase comprises a series of symbols.

10. The processor-based system of claim 9, wherein the symbols comprise one or more of numbers, letters, phonemes, and words.

11. A processor-implemented method of determining that a user of an interactive voice component is one of human and non-human, comprising:
by an audio validation component comprising a processor operatively coupled to a memory device:
generating a challenge phrase;
applying an effect to at least a portion of the challenge phrase, the effect comprising an echo perturbation, to form a modified challenge phrase,
issuing the modified challenge phrase to the user;
receiving a response from the user; and
evaluating the response to determine that the response is a correct response to the challenge phrase, such that (i) when the response is determined to be a correct response to the challenge phrase, designating the user as human, and (ii) when the response is determined to be an incorrect response to the challenge phrase, designating the user as non-human.

12. The method of claim 11, further comprising implementing the echo perturbation as C(t)+A*C(t−D), where t is time, C(t) is the challenge phrase, A is an amplitude value, and D is a delay value.

13. The method of claim 12, wherein the amplitude value is in the range of 0.2 to 0.7, and the delay value is in the range of 0.2 seconds to 0.7 seconds.

14. The method of claim 11, further comprising applying one or more non-echo effects to the challenge phrase, in addition to the echo perturbation.

15. The method of claim 14, further comprising selecting the one or more non-echo effects from a pool of non-echo effects.

16. The method of claim 15, wherein the pool of non-echo effects comprises (i) music, (ii) noise distribution, (iii) one or more pure tones, (iv) compression, (v) jitter, (vi) shimmer, and/or (vii) distorted pitch.

17. The method of claim 11, further comprising forming the challenge phrase that comprises a series of symbols, wherein the symbols comprise one or more of numbers, letters, phonemes, and words.

18. A processor-based system comprising:
at least one processor; and
a memory comprising code stored therein that, when executed by the at least one processor, performs a method of implementing a test to determine that the user is one of human and non-human, the test comprising:
a challenge phrase issued to the user;
an effect applied to the challenge phrase, the effect comprising an echo perturbation; and
an evaluation of a response received from the user to determine that the response is a correct response to the challenge phrase, such that (i) when the response is determined to be a correct response to the challenge phrase, the user is designated as human, and (ii) when the response is determined to be an incorrect response to the challenge phrase, the user is designated as non-human.

19. The processor-based system of claim 18, wherein the audio validation component comprises an auditory CAPTCHA.

20. The processor-based system of claim 18, wherein the echo perturbation is implemented as C(t)+A*C(t−D), where t is time, C(t) is the challenge phrase, A is an amplitude value, and D is a delay value.
